(19) United States
(12) Patent Application Publication
(10) Pub. No.: US 2001/0055514 A1
(43) Pub. Date: Dec. 27, 2001

(54) Device for connecting the tabletop to leg over table

(76) Inventor: Gunter von der Muhlen, Ennepetal (DE)

Correspondence Address: HORST KASPER, 13 FOREST DRIVE, WARREN, NJ, 07059, US

(21) Appl. No.: 09/873,462

(22) Filed: Jun. 4, 2001

(30) Foreign Application Priority Data
Jun. 2, 2000 (DE) 200 09 926.4

(51) Int. Cl. B25G 3/00

(52) U.S. Cl. 403/230

(57) ABSTRACT

A device for connecting of a leg table to a tabletop, wherein the device on the one hand is constructed modularly and consequently can be employed at any desired leg table, and on the other hand wherein the device also enables the use of legs of tables with different cross sections and also circular. This object is accomplished by a table adapter and at least one sleeve, wherein sleeves are inserted into the table adapter, wherein an outer cone is formed at the sleeves and wherein the legs of the table are insertable into the sleeves.

### FIELD OF THE INVENTION

The invention relates to a device for connecting the tabletop to a leg of a table by way of a table adapter and at least one sleeve.

### BRIEF DESCRIPTION OF THE BACKGROUND OF THE INVENTION INCLUDING PRIOR ART

The connection of legs of tables to tabletops is performed in a variety of ways. For example of it is known from the U.S. Pat. No. 3,322,384 A to furnish a stand at the bottom side of a tabletop, wherein receiver seats are disposed in the stand. In each case a leg over table is inserted into the receiver seats. It is also known to furnish a possibility at the legs of a table for attachment of the leg of the table to the tabletop (compare U.S. Pat. No. 4,867,610 A). For this purpose a base plate is furnished at the ends of the legs of a table disposed remote relative to the floor, wherein the base plate is screwed to a tabletop. The known connections between table legs and tabletops are associative with the disadvantage that the legs of the table in each case have to be adapted to the connection with the tabletop. In particular in the situation of legs of tables, which are furnished for attachment with a stand attached to the bottom side of the table, it is required that the leg of the table is adapted precisely to the receiver seats in the table stand. The field of application of the table legs is thereby very limited. A storing of table legs is difficult because the table legs are applicable in each case for only a limited number of tabletops.

A device for connecting over tabletop to a table leg is known from the printed patent document PCT/De99/02837 for eliminating of the disadvantage, wherein an adapter is furnished. A stub is formed at the adapter, wherein the stub protrudes into a table leg on the side of the table leg disposed toward the tabletop. The stub is a formed in the kind of a cone. A sleeve is put onto the stub. The known device for connecting of table legs to tabletops is constructed in modules. The known device consequently can be applied at any arbitrary table and otherwise fulfills all requirements plays onto the known device. However, based on the inwardly disposed cone is not possible to employ table legs with a cross-section different and then circular. The variability of the device is thereby limited.

The present invention intends to provide a remedy here. It is an object of the present invention to furnish a device for connecting of a leg over table to a tabletop, wherein the device on the one hand is constructed modularly and consequently can be employed at any desired leg over table, and on the other hand wherein the device also enables the use of legs of tables with cross sections different and than circular. This object is according to the present invention accomplished by furnishing that sleeves are insertable into the table adapter, wherein an outer cone is formed at the sleeves and wherein the sleeves are insertable into the table legs.

A device for connecting of table legs to table tops is furnished by the present invention, wherein the connection is constructed in modules and consequently is employable at any desired table. The possibility is generated at the same time based on the outer disposed cone that also legs of tables are employed having cross sections different than circular.

According to a particular embodiment of the invention the sleeves are furnished with a slot. The sleeve is pressed together during insertion of the sleeves into the table adapter such that the sleeve exerts an increased pressure onto the leg of the table. The stability of the connection between tabletop and leg of table is thereby increased.

According to a further feature of the invention the sleeves are formed at a clamping jaw. The employment of a clamping jaw allows the capturing of two sleeves in one construction part, whereby the possibility of handling of the connection between the tabletop and the legs of the table is increased, since two legs of a table are insertable into the clamping jaw.

According to a further embodiment of the invention at least one groove is formed in the clamping jaw. The moveability of the sleeves is increased thereby in connection with the slots furnished in the sleeve, such that an optimal transfer of the clamping forces is possible.

An elongated hole and/or holds are disposed in the table adapter according to a further development of the present invention. The elongated hole serves for receiving the clamping jaw and the holes serve for receiving of these sleeves.

Advantageously the holes are aligned under an angle relative to a vertical line. The possibility is created thereby to attach the legs of a table under an angle relative to a vertical line at the tabletop. On the one hand possibilities are thereby generated to increase the installation safety of the respective table and on the other hand advantages are thereby created with respect to the optical appearance picture of the table.

According to a further development of the present invention openings are furnished in the table adapter at a right angle relative to a vertical line. The openings serve for the receiving of traverses, wherein neighboring table adapters are connected to each other with the traverses. The possibility exists thereby to create a self carrying table under construction. In this case a screwing of the table adapter to the tabletop is not required, which is particularly advantageous when employing tabletops made of glass.

[Other embodiments and further developments are furnished in the remaining subclaims.]

And embodiment of the invention is illustrated in the drawing and is described in the following in detail. There is shown:

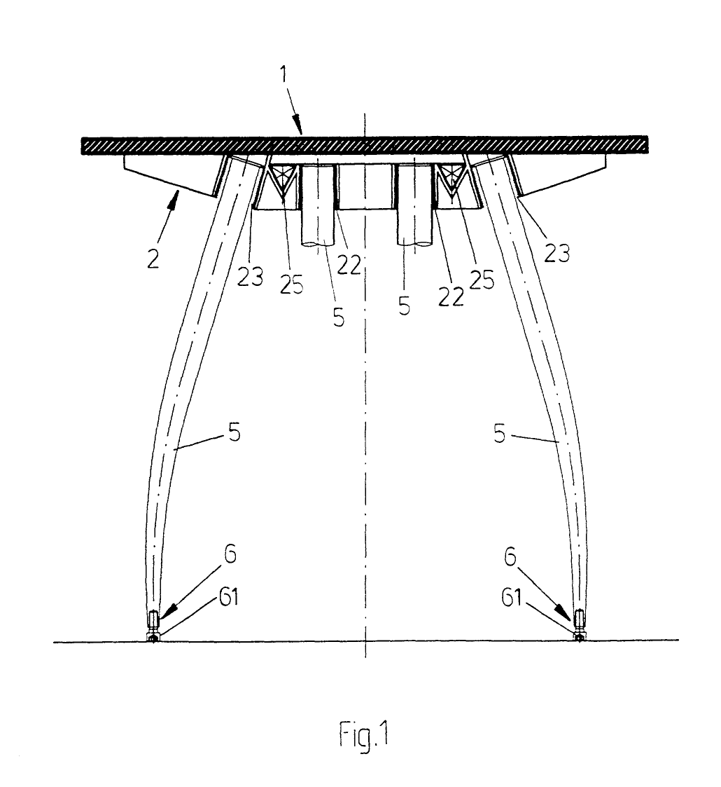

FIG. 1 a device with a tabletop, table adapter and legs of a table in a side elevation view;

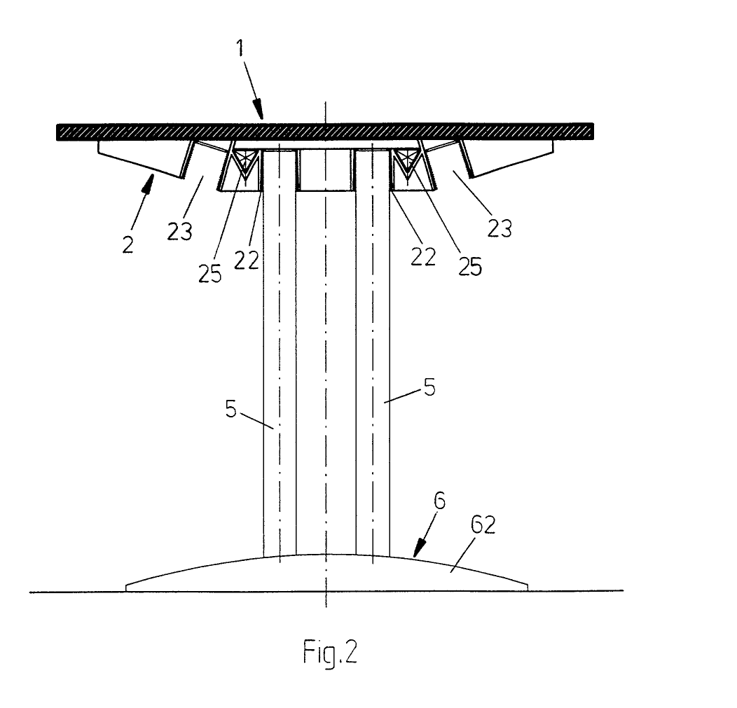

FIG. 2 side elevation view of the device in the different form;

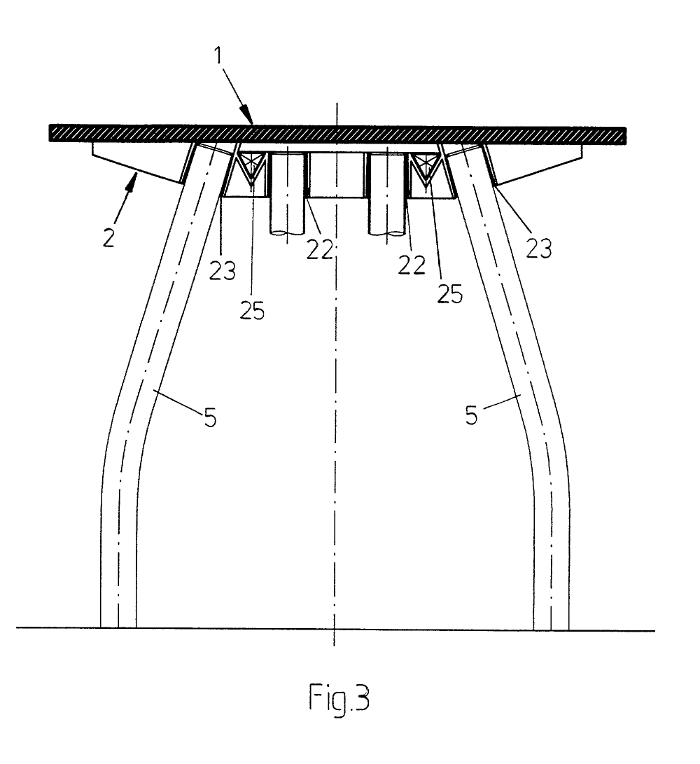

FIG. 3 a side elevation view of a device according to a further embodiment;

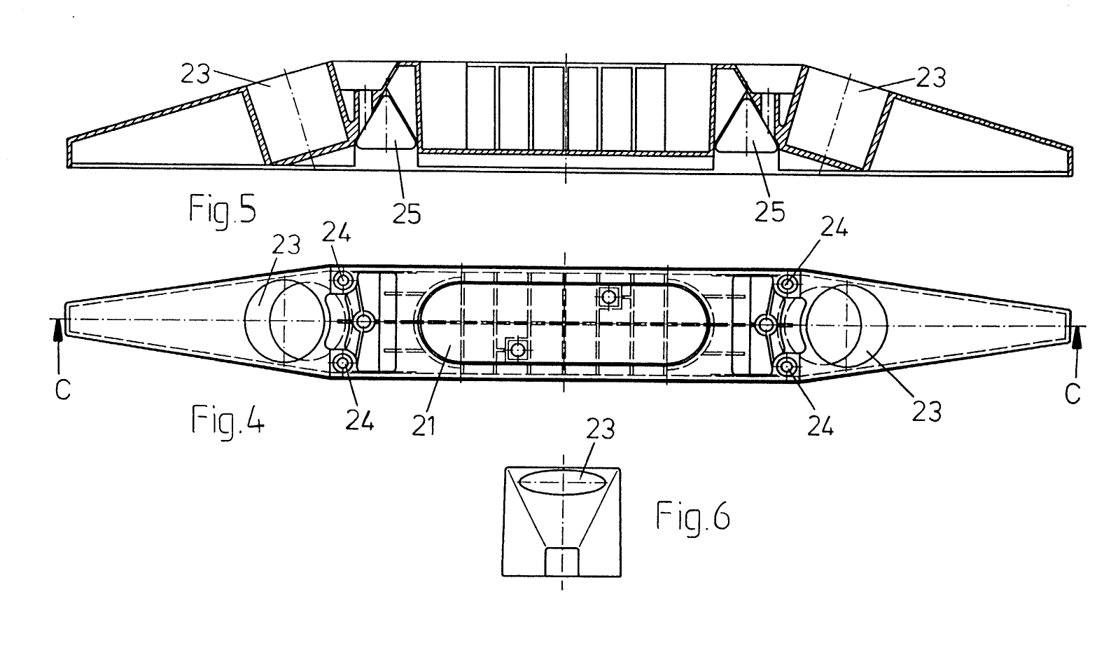

FIG. 4 the view from below onto a table adapter;

FIG. 5 a section along section line C-C in FIG. 4;

FIG. 6 a side elevation view from the left of the table adapter illustrated in FIG. 4;

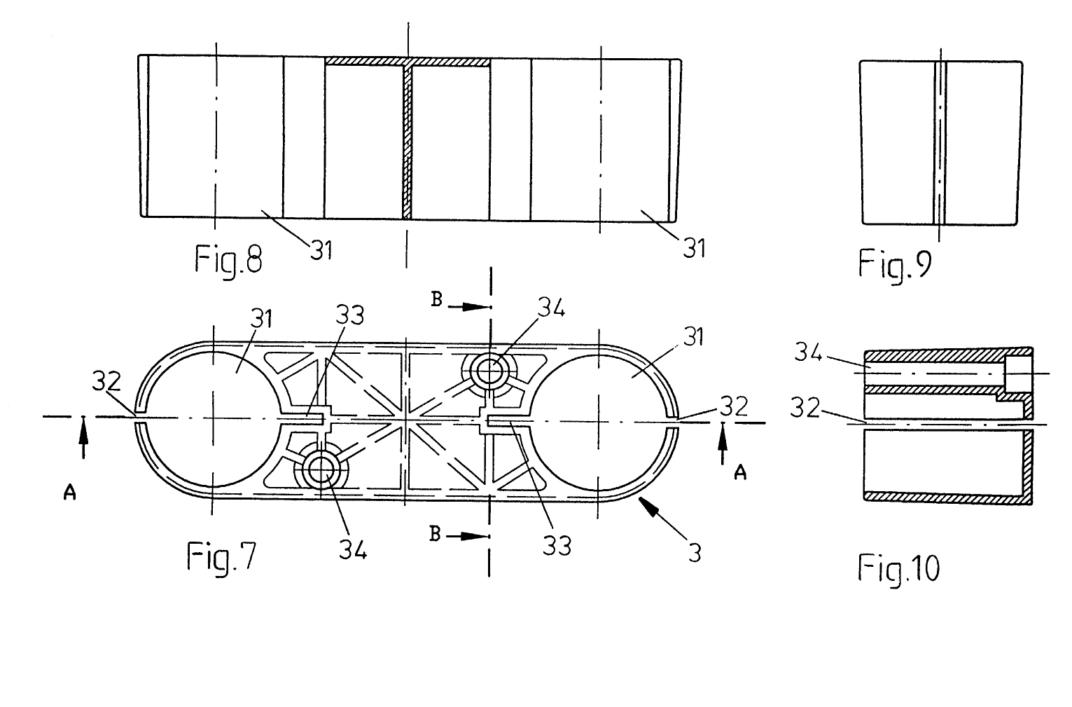

FIG. 7 a top planar view onto the clamping jaw;

FIG. 8 the section along section line A-A in FIG. 7;

FIG. 9 the side elevation view from the left of the clamping jaw illustrated in FIG. 7;

FIG. 10 the section along section line B-B in FIG. 7;

FIG. 11 the section through a cone sleeve;

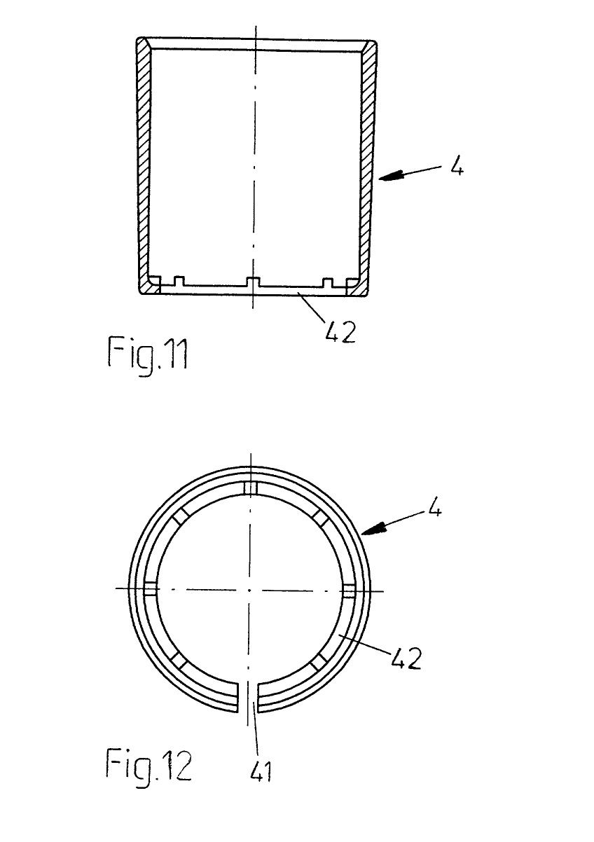

FIG. 12 a top planar view onto the conus sleeve illustrated in FIG. 7;

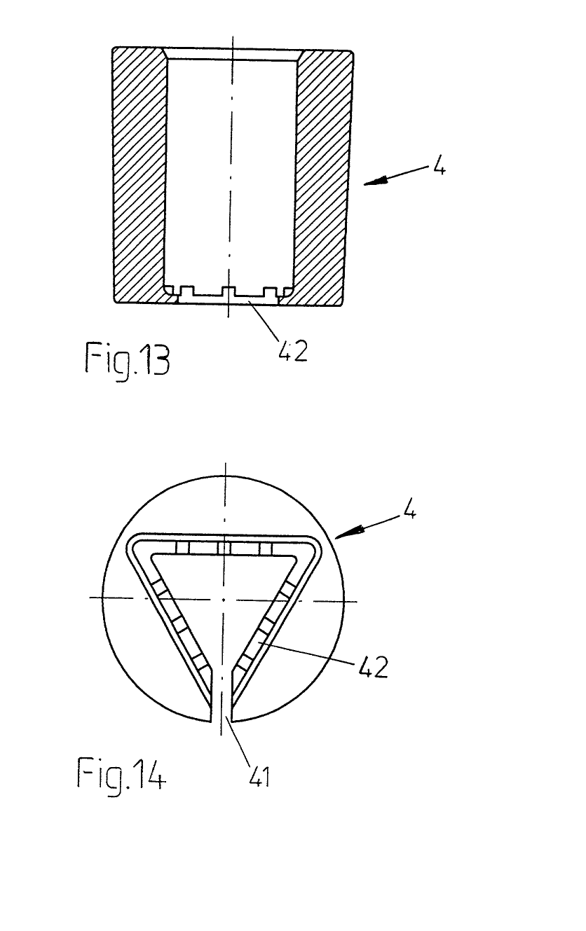

FIG. 13 a section through a cone sleeve according to another embodiment; and

FIG. 14 the top planar view onto the cone sleeve illustrated in FIG. 13.

The embodiment illustrated in the drawing exhibits a tabletop 1. A table adapter to his furnished at the side of the tabletop 1 disposed toward the floor—bottom side—. Clamping jaws 3 and/or sleeves 4 are insertable into the table adapter 2. At least one table leg 5 is insertable into the clamping jaws 3 or, respectively, the sleeves 4. Means 6 for installation of the leg of the table on the floor can be disposed at the ends facing the floor.

The tabletop 1 can be made out of an arbitrary and desired material. Usually the material is a wood plate or a plastic plate. In addition glass plates are possible.

The form and thickness of the tabletops is also freely selectable independent of the connection between tabletop and leg of table according to the present invention.

The table adapter 2 is made out of plastic. However, also other materials such as for example cast metal are possible. The table adapter 2 is not massive but formed as a rib construction (FIGS. 4 through 6). The rib shaped formation decreases on the one hand because of material and prevents on the other hand inhomogeneities within the material of the table adapter 2. At the same time the stability is high based on the ribbing.

The table adapter 2 has an elongated shape and is tipped at its ends. An elongated hole 21 serves for receiving the clamping jaw 3. Instead of the elongated hole 21 that can also be provided to individual holes 22, as this is illustrated in FIGS. 1 through 3. Two recesses or holes 23 are disposed outwardly from the cross center line in a direction toward the free ends, wherein the recesses or holds 23 are aligned under an angle relative to a vertical line (FIG. 5). Boreholes 24 are furnished distributed over the table adapter (in the embodiment example shown eight bore holes), wherein the boreholes 24 serve for attachment of the table adapter at the tabletop. Openings 25 are furnished in the table adapter at a right angle to a vertical line, wherein the openings 25 exhibits a triangular cross-section in the embodiment. The openings 25 serve for receiving of traverses—not illustrated—, wherein table adapters disposed neighboring to each other can be connected to each other with the traverses. Also other geometric forms are possible in addition to the triangular formation of the openings 25. The form of the traverse profile is adapted to the shape of the openings 25.

The clamping jaw 3 exhibits an outer contour, wherein the outer contour corresponds to the contour of the elongated hole 21. The clamping jaw 3 is not performed massive, but is furnished with a ribbing. Sleeves 31 are formed at the clamping jaw 3 at the two outer ends of the clamping jaw 3. The sleeves 31 serve for receiving the table legs 5. The sleeves 31 are furnished in each case with slots 32 at the sides disposed remote relative to each other, wherein the slots 32 extend over the full height of the sleeves 31.

In each case a groove 33 is formed in the clamping jaw 3 disposed diametrically opposed to the slots 32. Boreholes 34 are disposed in the clamping jaw 3 between the sleeves 31, wherein the clamping jaw 3 is attachable at the table adapter 2 or, respectively, at the tabletop 1 with the boreholes 34. The clamping jaw 3 exhibits on the outside a conical form and thus also the sleeves 31 exhibits on the outside a conical form; an outer cone is formed. The cone exhibits an angle of about 1.5 degrees.

An outer cone is formed at the sleeve 4. The outer cone exhibits also an angle of about 1.5 degrees. The cone sleeve 4 is furnished with a slot 41 extending over the full height of the sleeve. The sleeve exhibits on the inside a circular cross-section according to the embodiments shown in FIGS. 11 and 12. Therefore the sleeve is furnished with a circular cross-section for the receiving of the table legs. The sleeve of the cone exhibits is triangular in the cross-section according to the embodiments in FIGS. 13 and 14. The cone sleeve is therefore furnished for the receiving of table legs having a triangular cross-section. In addition, all other geometric reforms are possible for the inner cross-section of the cone sleeve 4. The cone sleeve 4 is furnished with an internal flange 42 at the end of the cone sleeve 4 facing the tabletop. The table leg 5 with its end disposed toward the tabletop 1 is supported against this internal flange 42 in an assembled state.

The table legs 5 exhibit a circular cross-section in the embodiments with the exception of FIGS. 13 and 14. The table legs 5 are disposed in the recesses or holes 23 according to the embodiment of FIG. 2 and are therewith already in the table adapter 2 at a right angle relative to the floor. The table legs 5 are consequently formed straight line. The table legs 5 exhibit a uniform cross-section in the embodiments according to FIGS. 2 and 3. In contrast to cross-section narrowing in the direction of the floor is formed in the embodiment according to FIG. 1.

The means 6 for installing are disposed at the table legs 5 at the end of the means 6 disposed remote relative to the table. Individual adjusting feet 61 are inserted into the table legs 5 according to the embodiment of FIG. 1. The adjusting feet 61 can be inserted into the table legs 5 or also can be screwed into the table legs 5. The possibility of screwing in offers at the same time the possibility to perform a height level adjustment with the aid of the adjusting feet 61. In contrast the table legs 5 are inserted together into a table foot 62 according to the embodiment of FIG. 2. It is assured by the width of the table foot 62 that the thus constructed table exhibits a high safety against flipping over the winning case of a one-sided load of the tabletop 1.

The table legs 5 are inserted into the sleeves 31 of the clamping jaw 3 or, respectively into the cone sleeves 4 during assembly of the device. The internal flanges 42 serve as a stop relative to the cone sleeves 4. The clamping jaw 3 or, respectively, the cone sleeves 4 are then inserted in the openings in the shape of an elongated hole 21 or, respectively, the recesses or holes 23 furnished at the table adapter 2. A clamping effect is generated during the insertion into the elongated hole 21 or, respectively, the recesses or holes 23 based on the cone like form at the outer sides of the clamping jaw 3 as well as of the cone sleeves 4. Moveability is generated based on the slots 32 and 41 furnished in each case, wherein the moveability leads to a reduction in diameter upon a further insertion into the table adapter, whereby the clamping force acting on the legs 5 of the table is increased. At the same time a self inhibition is generated in the connection between the table adapter 2 and the clamping jaw 3 or, respectively, the cone sleeve 4 based on the selection of the cone angle such that overall stable connection is generated. In addition, the boreholes 34 in the clamping jaw 3 offer the possibility to screw the clamping jaw to the table adapter 2. The table adapter 2 to itself can be screwed to the tabletop 1 with the aid of the boreholes 24. The formation of a self-supporting construction is generated if traverses are inserted into the openings 25 of the table adapter 2. At table under construction is created by the connection of two neighboring table adapters 2 with the aid of traverses, wherein the table adapters 2 do not have to be screwed to the tabletop 1. Business in particular extremely advantageous upon using of tabletops out of glass, since the drilling in glass plates is very expensive and since the drilling in glass plates can be dispensed with in case of her self carrying construction. In addition, the traverses offer the possibility to attach drawers under the tabletop.

1. Device for connecting of a tabletop to a leg of a table with a table adapter and at least one sleeve, wherein sleeves (31,4) are inserted into the table adapter (2), wherein an outer cone is formed at the sleeves (31,4) and wherein the legs (5) of the table are insertable into the sleeves (31, 4).

2. The device according to claim 1 wherein the outer cone exhibits an angle of about 1.5 degrees.

3. The device according to claim 1 wherein the sleeves (31,4) are furnished with a slot (32, 41).

4. The device according to claim 3 wherein the slots (32, 41) extend over the full height of the sleeves (31,4).

5. The device according to claim 1 wherein the sleeves (31) are formed as a clamping jaw (3).

6. The device according to claim 5 wherein at least one groove (33) is formed in the clamping jaw (3).

7. The device according to claim 1 wherein an elongated hole (21) and/or recesses or holes are disposed in the table adapter (2).

8. The device according to claim 7 wherein the recesses or holes (23) are aligned under an angle relative to a vertical line.

9. The device according to claim 1 wherein openings (25) are furnished in the table adapter (2) disposed at a right angle relative to a vertical line.

10. A device for connecting of a tabletop to a leg of a table comprising
a table adapter for attachment to a tabletop;
at least one sleeve formed as a cone on its outer face and inserted into the table adapter;
a table leg (5) of the tabletop capable of being inserted into the sleeve.

11. The device according to claim 10 wherein the outer cone exhibits an angle of from about 0.5 to 5 degrees.

12. The device according to claim 11 wherein the sleeve (31,4) is furnished with a longitudinal slot (32, 41) and wherein the outer cone exhibits an angle of from about 1.0 to 2.0 degrees.

13. The device according to claim 12 wherein the longitudinal slot (32, 41) extends over the full height of the sleeve (31,4).

14. The device according to claim 10 wherein the sleeve (31) is formed as a clamping jaw (3).

15. The device according to claim 14 further comprising
a groove (33) formed in the clamping jaw (3) an wherein the adapter is made of plastic.

16. The device according to claim 10 wherein an elongated hole (21) or recess is disposed in the table adapter (2).

17. The device according to claim 10 wherein a hole (23) or recess is aligned under an angle relative to a vertical line.

18. The device according to claim 10 further comprising
an opening (25) furnished in the table adapter (2) and disposed at a right angle relative to a vertical line.

19. A kit for producing a table comprising
a tabletop;
a table adapter capable of attachment to the table top and having a recess exhibiting an inner conical face;
a sleeve formed as a cone on its outer face and having an inner face and capable of insertion into the recess of the table adapter;
a leg having an upper end matching the inner face of the sleeve.
